(19) United States
(12) Patent Application Publication
(10) Pub. No.: US 2020/0132854 A1
(43) Pub. Date: Apr. 30, 2020

(54) RADIO RECEIVERS FOR POSITION DETERMINATION SYSTEMS

(71) Applicant: Continental Teves AG & Co. oHG, Frankfurt am Main (DE)

(72) Inventors: Bernd Kubina, Frankfurt am Main (DE); Sebastian Strunck, Niedernhausen (DE); Roland Burghardt, Frankfurt am Main (DE); Robert Bodenheimer, Idstein (DE)

(21) Appl. No.: 16/606,423

(22) PCT Filed: Apr. 23, 2018
(86) PCT No.: PCT/EP2018/060266

§ 371 Date: Oct. 18, 2019

(30) Foreign Application Priority Data
May 5, 2017 (DE) 10 2017 207 575.9

(51) Int. Cl. G01S 19/22; G01S 19/35; G01S 19/42; H01Q 21/24

(52) U.S. Cl. CPC G01S 19/22; H01Q 21/245; G01S 19/428; G01S 19/35

(57) ABSTRACT

A radio receiver for receiving radio signals from at least one position determination system, having a receiving apparatus, and an antenna arrangement. The antenna arrangement has at least one radio signal antenna for receiving radio signals and a first feed element and a second feed element. The first feed element and the second feed element have different polarization-dependent sensitivities. The antenna arrangement has a first radio signal line and a second radio signal line. The first radio signal line is designed to provide a radio signal received by the antenna arrangement as a first radio reception signal. The second radio signal line is designed to provide a further radio signal received by the antenna arrangement as a second radio reception signal. A signal processing apparatus designed to determine a position of the radio receiver on the basis of the first radio reception signal and the second radio reception signal.

### CROSS REFERENCE TO RELATED APPLICATIONS

This application is the U.S. National Phase application of PCT International Application No. PCT/EP2018/060266, filed Apr. 23, 2018, which claims priority to German Patent Application No. 10 2017 207 575.9, filed May 5, 2017, the contents of such applications being incorporated by reference herein.

### FIELD OF THE INVENTION

The present disclosure relates to a radio receiver for receiving radio signals from at least one position determination system, in particular a global navigation system, for local position determination.

### BACKGROUND OF THE INVENTION

Radio receivers for position determination systems are designed to receive radio signals from transmitting stations, for example satellites. Triangulation can be used by the radio receiver, with a sufficiently large number of received radio signals, to determine its position in three-dimensional space. In particular in the surroundings of buildings or other obstacles, however, it may be that the signal path of the radio signals is not a direct path between transmitting station and radio receiver, but rather that the radio signals are scattered and/or reflected by obstacles. If this is not detected by the radio receiver, there is the resultant disadvantage of less accurate and/or erroneous position determination for the radio receiver.

### SUMMARY OF THE INVENTION

An aspect of the disclosure is a more efficient radio receiver for position determination systems that realizes in particular improved position determination with increased accuracy and a reduced error rate by means of efficient processing of the received radio signals.

An aspect of the disclosure is based on the insight that the above object can be achieved by a radio receiver that can receive and process differently polarized radio signals. A reflected and/or scattered radio signal can have an altered polarization in comparison with the originally transmitted radio signal. The radio receiver is in polarization-sensitive form, so that a distinction can be drawn between signals received directly and/or signals received in scattered or reflected fashion.

According to a first aspect, the disclosure relates to a radio receiver for receiving radio signals from at least one position determination system having a receiving apparatus, which has an antenna arrangement, wherein the antenna arrangement has at least one radio signal antenna for receiving radio signals and also a first feed element and a second feed element, wherein the first feed element and the second feed element have different polarization-dependent sensitivities, wherein the antenna arrangement has a first radio signal line and a second radio signal line, wherein the first radio signal line is designed to provide a radio signal received by the antenna arrangement as a first radio reception signal, and wherein the second radio signal line is designed to provide a further radio signal received by the antenna arrangement as a second radio reception signal, and a signal processing apparatus designed to determine a position of the radio receiver on the basis of the first radio reception signal and the second radio reception signal.

The first radio signal line may be connected downstream of the first feed element, and the second radio signal line may be connected downstream of the second feed element. In particular, the respective radio signal line may be electrically connected to the respective feed element via a plug connection. Furthermore, the electrical connection between the respective radio signal line and the feed element may be a solder joint. In particular, the respective radio signal line may be integrated in the respective feed element.

The position determination system may be a global navigation system, which can have a plurality of transmitting stations. The position determination system may be satellite-assisted and in particular a global navigation satellite system (GNSS), for example the Global Positioning System (GPS) or the Galileo system.

The accuracy of the position determination by the radio receiver by using the position determination system can be advantageously increased by classifying the received radio signals into directly received and indirectly received radio signals. Directly received radio signals may be distinguished in that between a transmitting station of the position determination system and the radio receiver there are no obstacles that can significantly influence a radio signal transmitted by the transmitting station. Indirectly received radio signals may be distinguished in that between a transmitting station of the position determination system and the radio receiver there is at least one obstacle that can significantly influence the radio signal transmitted by the transmitting station. The reason for significant influencing of the radio signal may be in particular scattering and/or reflection by one or more surfaces of the obstacle, which means that the radio signal may have its polarization altered, for example.

The radio signal may be in particular a radio-frequency signal that can be reflected and/or scattered by surfaces of buildings. Scattered and/or reflected radio signals may be overlaid with direct radio signals at the radio receiver. The radio receiver according to an aspect of the invention may be designed to separate the overlaid radio signals. Furthermore, the radio receiver may be designed to distinguish between the reception of exclusively directly received radio signals, the reception of exclusively indirectly received radio signals and/or the reception of both directly and indirectly received radio signals.

The antenna arrangement of the radio receiver can have in particular different reception sensitivities for differently polarized radio signals, so that antenna information having the polarization-dependent reception sensitivity of the at least one radio signal antenna of the antenna arrangement can be provided. Using this antenna information and the first radio reception signal and the second radio reception signal, the radio receiver can ascertain the polarization and/or polarization components of the originally received radio signal and establish whether the received radio signal was transmitted directly or indirectly.

The antenna arrangement can have a plurality of physically separate radio signal antennas and/or at least one multi-feed antenna, wherein the radio signal lines that may be coupled to the radio signal antennas may be in the form of waveguides, in particular coaxial waveguides or planar waveguides.

In one embodiment, the first radio signal line and the second radio signal line are coupled to the at least one radio signal antenna.

The antenna can have a plurality of different, polarization-dependent reception sensitivities that can each be provided via a separate feed element. In particular, the antenna can have different reception sensitivities for differently circularly, elliptically and/or linearly polarized radio signals. Radio signals can induce an electric current in an electrical conductor of the antenna, said electric current being able to be provided to the signal processing apparatus as a radio reception signal.

In one embodiment, the antenna arrangement has a further radio signal antenna, wherein the first radio signal line is coupled to the first radio signal antenna, and wherein the second radio signal line is coupled to the second radio signal antenna.

The reception sensitivity of a radio signal antenna may be determined by the geometric shape and/or the interconnection of electrical conductors within the radio signal antenna. The use of separate radio signal antennas can realise different reception sensitivities, the respective radio signals being able to be provided to the signal processing apparatus as a radio received signal via a separate radio reception line. The separate radio signal antennas can have different direction-dependent reception sensitivities. Advantageously, the signal processing apparatus is provided with information about the reception characteristic of the radio signal antennas. In particular signal gain, polarization dependency, direction dependency and frequency range of the radio signal antenna can be relevant parameters for the further processing of the received radio signals by the signal processing apparatus.

In one embodiment, the signal processing apparatus is connected downstream of the receiving apparatus, and the signal processing apparatus is supplied with the first radio received signal via the first radio signal line and is supplied with the second radio received signal via the second radio signal line.

As such, each radio received signal may be associated with a specific radio signal antenna having a specific polarization-dependent reception sensitivity.

In one embodiment, the signal processing apparatus has antenna information about the polarization-dependent reception sensitivity of the first feed element and of the second feed element in order to use the first radio received signal and the second radio received signal to determine the polarization or polarization components of a radio signal received from the first feed element and the second feed element.

The first and second radio signal lines may be electrical, in particular coaxial or planar, conductors. The radio signal antenna of the antenna arrangement can convert the radio signal into a radio received signal. It may be necessary for the signal processing apparatus to be provided with antenna information that has at least the polarization-dependent reception sensitivities of the radio signal antenna. Using a radio signal antenna that has at least two different polarization-dependent reception sensitivities for radio signals and has at least two radio signal lines associated with the different reception sensitivities, the original polarization and/or applicable polarization components of a received radio signal can be determined by the signal processing apparatus.

In one embodiment, the signal processing apparatus is designed to use the antenna information to process the first radio received signal and the second radio received signal in order to distinguish whether the received radio signals were reflected and/or scattered before reception by the receiving apparatus.

The antenna information allows the signal processing apparatus to know the respective polarization-dependent reception sensitivity of the antenna elements. If the radio receiver knows what polarization a radio signal has when transmitted by the transmitting station, the radio receiver can take this information as a basis for processing the radio received signals in order to distinguish whether the received radio signals were reflected and/or scattered before reception by the receiving apparatus. This is possible because the polarization of a radio signal can change as a result of scatter and/or reflection.

In one embodiment, the signal processing apparatus is designed to split the first radio received signal and the second radio received signal into a plurality of digital signals and to perform a propagation time calculation for the plurality of digital signals in order to obtain position information for the radio receiver.

The first and second radio received signals may be radio-frequency signals that can be transmitted with a carrier signal at a frequency in the range from 0.1 GHz to 10 GHz, in particular at a frequency of 1.57 GHz. For the further processing of the radio received signals, it may be advantageous for the carrier signal of the radio received signals to be replaced by a lower-frequency carrier signal, so that the frequency range occupied by the radio received signals can have its frequency shifted as a frequency block. In particular, the low-frequency carrier signal can have a frequency in the range from 0 MHz to 15 MHz.

The first and second radio received signals may each be made up of a plurality of radio signals that can be transmitted by a plurality of transmitting stations. The intermediate-signal processor may be designed to discretize and separate this plurality of radio signals. This allows the radio signals to be separated for the different transmitting stations, in particular. This discretization and separation of the radio received signals can be effected in particular by means of sampling and/or correlation with the code division multiple access spreading sequences of the transmitting stations, in particular of the position determination system satellites. Subsequently, the signal processing apparatus can perform a pseudo-range calculation and thereby calculate a provisional position of the radio receiver. The pseudo-range calculation may be realized by a baseband processor, in particular.

In one embodiment, the signal processing apparatus is designed to generate final position information from the position information by means of a temporal shift of individual digital signals from the plurality of digital signals.

In one embodiment, the signal processing apparatus is designed to process the first radio received signal and the second radio received signal in sync.

The antenna arrangement can have a plurality of radio signal antennas and/or the respective radio signal antenna can have a plurality of antenna elements that can provide the signal processing apparatus with a plurality of radio received signals. The signal processing apparatus may be designed to process the plurality of radio received signals in sync.

The synchronization of the processing of the radio received signals in the signal processing apparatus achieves the advantage that the presence of indirectly received radio signals and the influence of the indirectly received radio signals on the position determination can be efficiently detected. The signal propagation time of the received radio signals may be different, the synchronous processing of the received radio signals being able to preserve this signal propagation time difference in order to process the time difference at a later time.

In one embodiment, the radio receiver further has a signal processor, in particular a radio-frequency signal processor, that is connected downstream of the antenna arrangement and is connected upstream of the signal processing apparatus, wherein the signal processor is designed to process the first radio received signal and the second radio received signal in sync in order to supply the first radio received signal and the second radio received signal in filtered and amplified fashion to the signal processing apparatus.

In one embodiment, an intermediate-frequency signal processor is connected downstream of the signal processor and is connected upstream of the signal processing apparatus, which intermediate-frequency signal processor is designed to process the first radio received signal and the second radio received signal in order to shift, in particular down-convert, the frequency of the first radio received signal and of the second radio received signal and to split them into a plurality of digital signals, before the plurality of digital signals is supplied to the signal processing apparatus.

In one embodiment, the signal processor and the intermediate-frequency signal processor are integrated in the signal processing apparatus.

In particular, the signal processing apparatus can have a software-defined radio that may be connected downstream of the signal processor and that can realise the correlation of the radio received signals and the pseudo-range calculation in a software program. The software-defined radio can replace the intermediate-frequency signal processor.

In one embodiment, the first radio received signal and the second radio received signal each have a separate signal processor and a separate intermediate-frequency signal processor provided for them, wherein the processing of the first radio received signal and the second radio received signal by the separate signal processors and the processing of the first radio received signal and the second radio received signal by the separate intermediate-frequency signal processors is in sync.

In one embodiment, the signal processing apparatus is designed to measure the signal strength of the first radio received signal and of the second radio received signal.

The measured signal strength of the radio received signals can be processed on the basis of the antenna information by the signal processing apparatus in order to determine the original polarization and/or polarization components of the received radio signals.

In one embodiment, the antenna arrangement has a multi-feed antenna designed to receive a plurality of radio signals having different polarizations and to provide the signal processing apparatus with a plurality of radio received signals.

The multi-feed antenna can have a plurality of feed elements for receiving circularly, linearly and/or elliptically polarized radio signals. A respective radio received signal of the respective radio signal antenna can be processed in the radio receiver. Processing of the signal strength and/or of the times of arrival of the individual radio received signals in the signal processing apparatus can provide firstly an indication of the presence of an indirectly received radio signal and secondly information about the temporal shift between directly and indirectly received radio signals. The temporal shift information can be used to infer a deviation in the performed pseudo-range calculation of a radio received signal received by a right-hand circularly polarized radio signal antenna.

The multi-feed antenna usable can be for example a dual circularly polarized antenna and/or dual linearly polarized antenna. Dual linearly polarized antennas can use polarisers to generate right-hand and left-hand circularly polarized radio signals in turn. The polarisers can in this case be made up of radio-frequency power splitters and delay elements. The use of multi-feed antennas can be particularly advantageous in this case if the available installation space is limited. A multi-feed antenna can have an advantageously reduced installation space in comparison with a plurality of separate antennas.

In one embodiment, the antenna arrangement is designed to receive right-hand polarized and left-hand polarized radio signals.

The radio signals transmitted by the transmitting stations of the positioning system, in particular by satellites, may be right-hand circularly polarized, i.e. the trajectory of the electrical field of the radio signals describes a circle. The circular trajectory can therefore be assigned two orthogonal radio signal components having approximately the same signal amplitude and a 90° phase shift. The directly received radio signal is primarily right-hand circularly polarized in accordance with the transmitted radio signal. The indirectly received radio signal can have a different polarization from the right-hand circular polarization of the directly received radio signal, however. The indirectly received radio signal may be reflected from a dielectric or metal object, for example, and can have nonidentical amplitudes of the orthogonal radio signal components. The circular trajectory is therefore deformed to produce an elliptically shaped trajectory of the electrical field of the radio signal. Moreover, the direction of rotation of the polarization can also change from right-handed to left-handed.

In one embodiment, the antenna arrangement has an array antenna designed to measure the angle of incidence of received radio signals.

The angle of incidence of received radio signals can be processed by the signal processing apparatus in order to perform a plausibility check with position information of the transmitting stations of the position determination system: If the radio receiver receives a plurality of radio signals from different transmitting stations and if the radio receiver additionally knows the position of the transmitting stations, the radio receiver can ascertain the position of the radio receiver by comparing the angles of incidence of the received radio signals. An indirectly received radio signal can have a reception angle that differs from the expected reception angle when the radio signal is received directly. The radio receiver can therefore use the angle of incidence to establish whether a radio signal was received directly or indirectly. Information about the angle of incidence of a radio signal can be combined with the antenna information about the polarization of a radio signal in order to distinguish between directly and indirectly received radio signals and hence to improve the position determination by the radio receiver, and in particular to determine a more accurate position.

In one embodiment, the radio receiver has a clock generator designed to synchronize the processing of the first radio received signal and the second radio received signal by the signal processor and the intermediate-frequency signal processor.

The clock generator may be integrated in one of the signal processors and/or intermediate-frequency signal processors, wherein the clock generator synchronizes the processing of the radio received signals and can advantageously preserve a signal propagation time difference of the radio received signals. Referring to the embodiment in which each radio received signal is designed to have a separate signal processor and a separate intermediate-frequency signal processor, the clock generator may be electrically connected to all signal processors and/or intermediate-frequency signal processors in order to synchronize the signal processing in all signal processors and/or intermediate-frequency signal processors. Furthermore, the signal processors and/or intermediate-frequency signal processors may be designed to synchronize the signal processing among one another. Further, a single signal processor may be designed to synchronize all other signal processors and/or intermediate-frequency signal processors. Further, a single intermediate-frequency signal processor may be designed to synchronize all other signal processors and/or intermediate-frequency signal processors.

In one embodiment, the radio receiver can be used in position determination systems that use sensor data combination, in particular with inertial sensors, to realise position determination even when the radio signals of the position determination system are shadowed, for example by tunnels.

In one embodiment, the radio receiver can detect fake radio signals of the position determination system (spoofing) by processing the radio signals.

### BRIEF DESCRIPTION OF THE DRAWINGS

Further exemplary embodiments are explained with reference to the accompanying figures, in which:

FIGS. 1, 2 and 3 show a few embodiments of a radio receiver;

FIGS. 4A and 4B show a few embodiments of an antenna arrangement;

FIG. 5 shows one embodiment of a signal processor and an intermediate-frequency signal processor; and

FIGS. 6 and 7 show a few embodiments of reception of radio signals by the radio receiver.

### DETAILED DESCRIPTION OF THE PREFERRED EMBODIMENTS

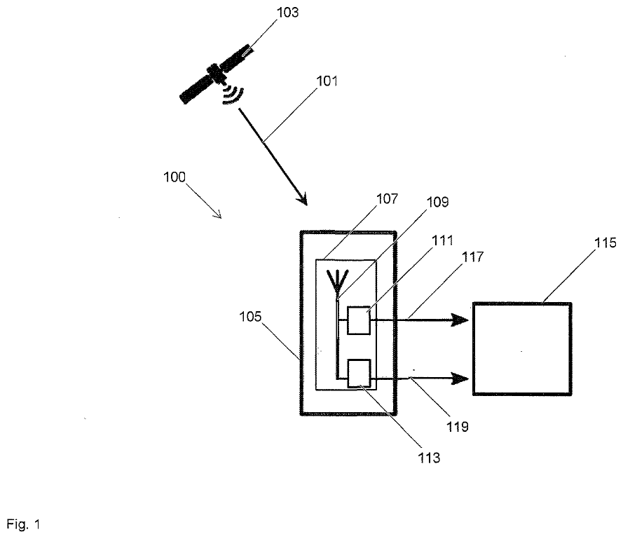

FIG. 1 shows a schematic depiction of a radio receiver 100 for receiving radio signals 101 from at least one position determination system 103. The radio receiver 100 comprises a receiving apparatus 105, which has an antenna arrangement 107, wherein the antenna arrangement 107 has at least one radio signal antenna 109 for receiving radio signals 101 and a first feed element 111 and a second feed element 113. The first feed element 111 and the second feed element 113 have different polarization-dependent sensitivities. The antenna arrangement 107 has a first radio signal line 117 and a second radio signal line 119, wherein the first radio signal line 117 is designed to provide a radio signal received by the antenna arrangement 107 as a first radio received signal and the second radio signal line 119 is designed to provide a further radio signal received by the antenna arrangement 107 as a second radio received signal. The radio receiver 100 has a signal processing apparatus 115 designed to determine a position of the radio receiver 100 on the basis of the first radio received signal and the second radio received signal.

The radio receiver 100 can be at an arbitrary position relative to the transmitting stations of the position determination system 103. The distance between transmitting station and radio receiver 100 may be limited by the signal strength of the radio signal 101 transmitted by the transmitting station and the antenna gain of the antenna arrangement 107. Position determination in three-dimensional space can involve radio signals 101 from three transmitting stations being used. Since the time between the position determination system 103 and the radio receiver 100 may be asynchronous, a fourth transmitting station can be used in order to realise accurate position determination for the radio receiver 100. The radio receiver 100 may be arranged in a smartphone, vehicle on the earth's surface or aircraft in the atmosphere, in particular. To determine the position of the radio receiver 100, it may be advantageous for the radio receiver 100 to know the position of the transmitting stations, or for the position of the transmitting stations to be contained in the radio signals 101 as information.

In one embodiment, the radio signals 101 of the transmitting stations of the position determination system 103 are right-hand circularly polarized. In order to detect changes in the polarization of the originally right-hand circularly polarized radar signal 101, the antenna arrangement 107 can advantageously have at least one radio signal antenna 109 that can have different reception sensitivities for circularly and/or elliptically polarized radio signals 101 and can provide said reception sensitivities as radio received signals via different radio signal lines 117, 119. For example one radio signal antenna 109 having an increased reception sensitivity for right-hand circularly polarized radio signals 101 as compared with radio signals 101 having other polarizations and one radio signal antenna 109 having an increased reception sensitivity for left-hand circularly polarized radio signals as compared with radio signals 101 having other polarizations.

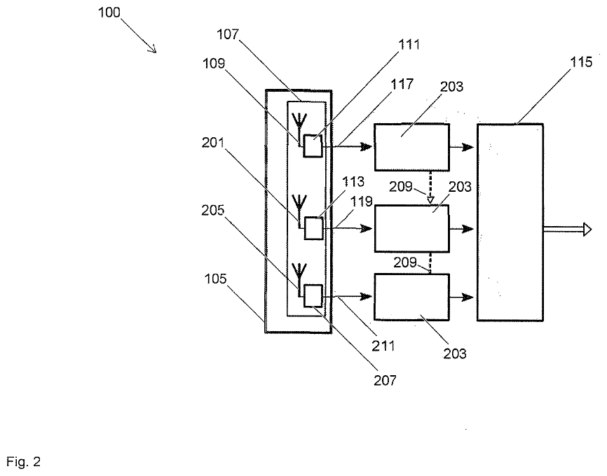

FIG. 2 shows a schematic depiction of a radio receiver 100 that further has a signal processor 203, in particular a radio-frequency signal processor, that is connected downstream of the antenna arrangement 107 and is connected upstream of the signal processing apparatus 115, wherein the signal processor 203 is designed to process the first radio received signal and the second radio received signal in sync in order to supply the first radio received signal and the second radio received signal in filtered and amplified fashion to the signal processing apparatus 115.

The first radio received signal and the second radio received signal can each be designed to have a separate signal processor 203, wherein the processing of the first radio received signal and of the second radio received signal by the separate signal processors 203 is in sync.

The signal processors 203 may be connected to one another via an electrical line, in particular a synchronization line 209, wherein the processing of the radio received signals by the signal processors 203 can be in sync via the synchronization line 209.

The antenna arrangement 107 can have a plurality of radio signal antennas 109, 201, 205, in particular three radio signal antennas 109, 201, 205, that may each be connected, in particular electrically connected, to the signal processor 203 via a separate radio signal line 117, 119, 211. The radio received signals processed by the separate signal processors 203 may be provided to the signal processing apparatus 115 via separate signal lines. The signal processing apparatus 115 generates position information that may be provided for further processing. In addition to the position information, the signal processing apparatus 115 can provide further information concerning the received radio signals 101. This information may be the polarizations, the signal levels, the angles of incidence, the frequency and/or the number of received radio signals 101, in particular. Moreover, information about the number and/or position of the transmitting stations from which the radio receiver 100 has received a radio signal 101 may be provided.

The extension of the antenna arrangement 107 by the plurality of radio signal antennas 109, 201, 205, in particular the extension by a plurality of feed elements 111, 113, 207, may have advantageously increased the power of the radio receiver 100, in particular in regard to more accurate and/or faster position determination.

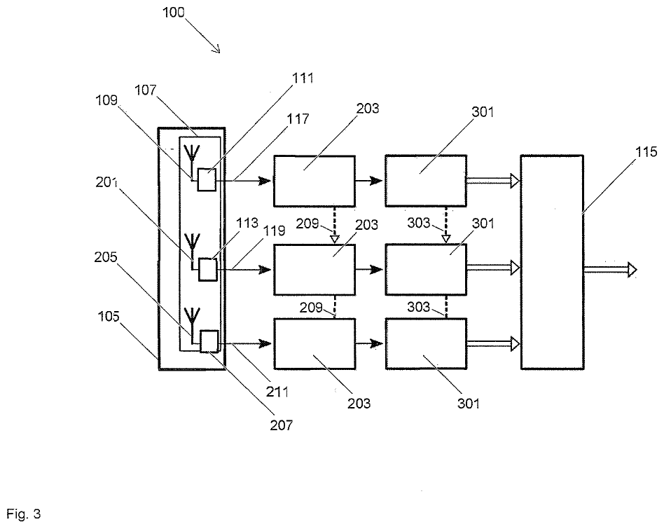

FIG. 3 shows a schematic depiction of a radio receiver 100, which has an intermediate-frequency signal processor 301 that is connected downstream of the signal processor 203 and is connected upstream of the signal processing apparatus 115. The intermediate-frequency signal processor 301 is designed to process the first radio received signal and the second radio received signal in order to shift, in particular down-convert, the frequency of the first radio received signal and of the second radio received signal and to split them into a plurality of digital signals 501, before the plurality of digital signals 501 is supplied to the signal processing apparatus 115.

The signal processor 203 and the intermediate-frequency signal processor 301 may be integrated in the signal processing apparatus 115.

The first radio received signal and the second radio received signal may each be designed to have a separate signal processor 203 and a separate intermediate-frequency signal processor 301, wherein the processing of the first radio received signal and the second radio received signal by the separate signal processors 203 and the processing of the first radio received signal and the second radio received signal by the separate intermediate-frequency signal processors 301 is in sync.

The intermediate-frequency signal processors 301 may be connected to one another via an electrical line, in particular a synchronization line 303, wherein the processing of the radio received signals by the intermediate-frequency signal processors 301 can be in sync via the synchronization line 209.

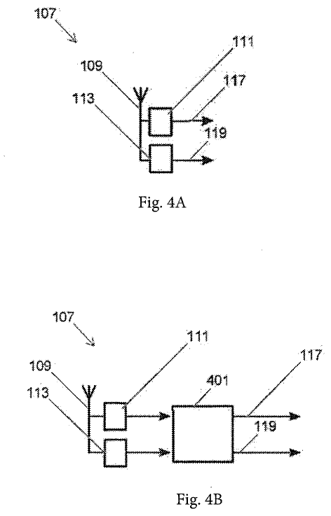

FIG. 4A shows a schematic depiction of the antenna arrangement 107, which has a radio signal antenna 109 for receiving radio signals 101. The first feed element 111 and the second feed element 113 have different polarization-dependent sensitivities, and the first radio signal line 117 is designed to provide a first radio received signal and the second radio signal line 119 is designed to provide a second radio received signal.

The integration of two different polarization-dependent reception sensitivities in one radio signal antenna 109 may have advantageously reduced the installation space of the antenna arrangement 107.

FIG. 4B shows a schematic depiction of the antenna arrangement 107, which has a radio signal antenna 109 for receiving radio signals 101. The first feed element 111 and the second feed element 113 have different polarization-dependent sensitivities, and the first radio signal line 117 is designed to provide a first radio received signal and the second radio signal line 119 is designed to provide a second radio received signal.

In particular, the radio signal antenna 109 can have two different linear-polarization-dependent reception sensitivities, forming an angle, and can supply the differently linearly polarized radio signals 101 to a polariser 401 as radio received signals via separate lines. The polariser 401 may be part of the antenna arrangement 107. The polariser 401 may be designed to convert the radio signals 101 received in linear-polarization-dependent fashion into circularly polarized signals.

The radio signal antenna 109 may be a dual linearly polarized radio signal antenna 109, in particular. The polariser 401 can be made up of radio-frequency power splitters and/or delay elements. Furthermore, multi-feed antennas can be used, so that the installation space of the antenna arrangement 107 may advantageously have been reduced.

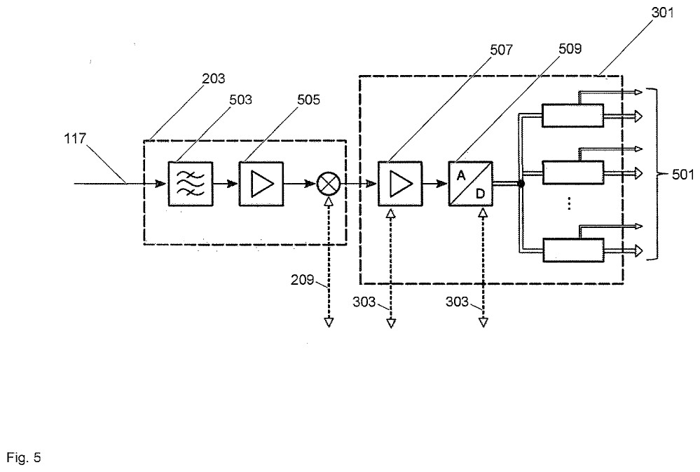

FIG. 5 shows a schematic depiction of the processing of a radio received signal using the signal processor 203 and the intermediate-frequency signal processor 301. The signal processor 203 has a filter apparatus 503 to which the radio received signal is provided via the radio signal line 117. The filter apparatus 503 is designed to filter the radio received signal. Furthermore, the signal processor 203 has an amplification apparatus 505 designed to amplify the radio received signal. The processing of the radio received signal by the signal processor 203 may be connected to further signal processors by the synchronization line 209, so that the signal processing by the signal processor and the further signal processors can be in sync.

The intermediate-frequency signal processor 301 can have a further amplification apparatus 507, to which the radio received signal processed by the signal processor 203 is provided. The further amplification apparatus 507 may be designed to amplify the radio received signal and to provide it to an analog-to-digital converter 509. The analog-to-digital converter 509 may be designed to shift the radio received signal from a first carrier signal to a second carrier signal, to sample and/or correlate the radio received signal and/or to split the radio received signal into a plurality of digital signals 501. The signal processing apparatus 115 can realise further splitting of the signals into baseband signals of the transmitting stations and associated correlator signals, which together form the digital signals 501 that can be provided at a signal output of the intermediate-frequency signal processor 301.

The further amplification apparatus 507 and/or the analog-to-digital converter 509 can be in sync via shared or separate synchronization lines 303, so that the processing of the radio received signals with amplification apparatuses and analog-to-digital converters in further intermediate-frequency signal processors 301 can be in sync.

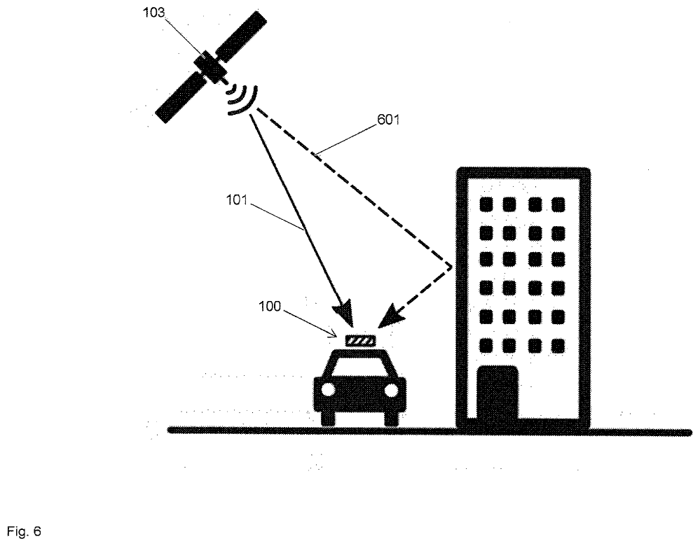

FIG. 6 shows a schematic depiction of a radio receiver 100 that receives a direct radio signal 101 and/or an indirect radio signal 601 from the position determination system 103. In particular, the direct and indirect radio signals 101, 601 may be sent by the same transmitting station of the position determination system 103.

The radio receiver 100 may be arranged in a vehicle and/or the indirect radio signal 601 may be reflected from an obstacle, in particular a building. The reflection of the indirect radio signal 601 by the obstacle means that the polarization of the indirect radio signal 601 can change. In particular, the polarization direction may have changed from right-hand circular to left-hand circular. Furthermore, the reception angle and/or signal strength of the indirect radio signal 601 can differ from the reception angle and/or signal strength of the direct radio signal 101.

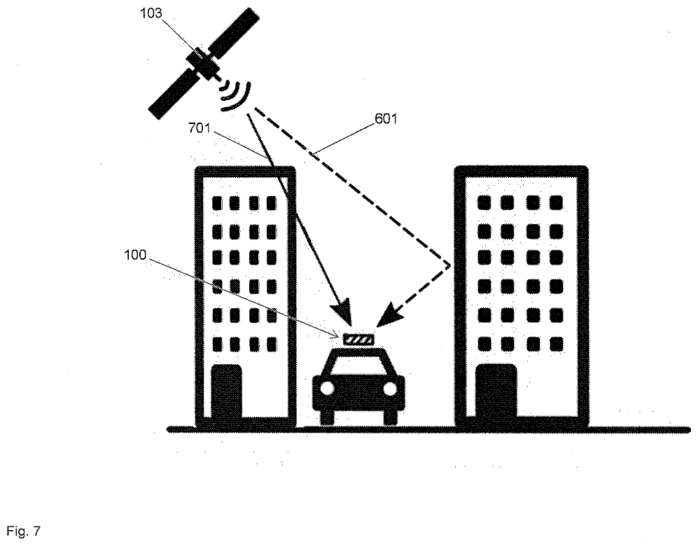

FIG. 7 shows a schematic depiction of a radio receiver 100 that receives two indirect radio signals 601, 701 from the position determination system 103. In particular, the two indirect radio signals 601, 701 may be sent by the same transmitting station of the position determination system 103.

The indirect radio signal 601 may be reflected from an obstacle, in particular a building. The indirect radio signal 701 may be scattered from an obstacle, in particular a building. The reflection and/or scatter of the radio signals 601, 701 by an obstacle means that the polarization, reception angle and/or signal strength of the respective radio signal 601, 701 can change. In particular, the interaction with an obstacle may have changed the polarization of the indirect radio signals 601, 701 from circularly polarized to elliptically polarized.

### LIST OF REFERENCE SIGNS

100 Radio receiver
101 Radio signal
103 Position determination system
105 Receiving apparatus
107 Antenna arrangement
109 Radio signal antenna
111 Feed element
113 Feed element
115 Signal processing apparatus
117 Radio signal line
119 Radio signal line
201 Radio signal antenna
203 Signal processor
205 Radio signal antenna
207 Feed element
209 Synchronization line
211 Radio signal line
301 Intermediate-frequency signal processor
303 Synchronization line
401 Polariser
501 Digital signal
503 Filter apparatus
505 Amplification apparatus
507 Amplification apparatus
509 Analog-to-digital converter
601 Radio signal
701 Radio signal

1. A radio receiver for receiving radio signals from at least one position determination system, comprising:
a receiving apparatus, which has an antenna arrangement, wherein the antenna arrangement has at least one radio signal antenna for receiving radio signals and also a first feed element and a second feed element, wherein the first feed element and the second feed element have different polarization-dependent sensitivities, wherein the antenna arrangement has a first radio signal line and a second radio signal line, wherein the first radio signal line is designed to provide a radio signal received by the antenna arrangement as a first radio received signal, and wherein the second radio signal line is designed to provide a further radio signal received by the antenna arrangement as a second radio received signal; and
a signal processing apparatus designed to determine a position of the radio receiver on the basis of the first radio received signal and the second radio received signal.

2. The radio receiver as claimed in claim 1, wherein the first radio signal line and the second radio signal line are coupled to the at least one radio signal antenna.

3. The radio receiver as claimed in claim 1, wherein the antenna arrangement has a further radio signal antenna, wherein the first radio signal line is coupled to the first radio signal antenna, and wherein the second radio signal line is coupled to the second radio signal antenna.

4. The radio receiver as claimed in claim 1, wherein the signal processing apparatus is connected downstream of the receiving apparatus, and the signal processing apparatus is supplied with the first radio received signal via the first radio signal line and is supplied with the second radio received signal via the second radio signal line.

5. The radio receiver as claimed in claim 1, wherein the signal processing apparatus has antenna information about the polarization-dependent reception sensitivity of the first feed element and of the second feed element in order to use the first radio received signal and the second radio received signal to determine the polarization or polarization components of a radio signal received from the first feed element and the second feed element.

6. The radio receiver as claimed in claim 5, wherein the signal processing apparatus is designed to use the antenna information to process the first radio received signal and the second radio received signal in order to distinguish whether the received radio signals were reflected and/or scattered before reception by the receiving apparatus.

7. The radio receiver as claimed in claim 1, wherein the signal processing apparatus is designed to split the first radio received signal and the second radio received signal into a plurality of digital signals and to perform a propagation time calculation for the plurality of digital signals in order to obtain position information for the radio receiver.

8. The radio receiver as claimed in claim 7, wherein the signal processing apparatus is designed to generate final position information from the position information by a temporal shift of individual digital signals from the plurality of digital signals.

9. The radio receiver as claimed in claim 1, wherein the signal processing apparatus is designed to process the first radio received signal and the second radio received signal in sync.

10. The radio receiver as claimed in claim 1, which further has a radio-frequency signal processor, that is connected downstream of the antenna arrangement and is connected upstream of the signal processing apparatus, wherein the signal processor is designed to process the first radio received signal and the second radio received signal in sync in order to supply the first radio received signal and the second radio received signal in filtered and amplified fashion to the signal processing apparatus.

11. The radio receiver as claimed in claim 10, wherein an intermediate-frequency signal processor is connected downstream of the signal processor and is connected upstream of the signal processing apparatus, which intermediate-frequency signal processor is designed to process the first radio received signal and the second radio received signal in order to shift the frequency of the first radio received signal and of the second radio received signal and to split them into a plurality of digital signals, before the plurality of digital signals is supplied to the signal processing apparatus.

12. The radio receiver as claimed in claim 11, wherein the signal processor and the intermediate-frequency signal processor are integrated in the signal processing apparatus.

13. The radio receiver as claimed in claim 11, wherein the first radio received signal and the second radio received signal each have a separate signal processor and a separate intermediate-frequency signal processor provided for them, wherein the processing of the first radio received signal and the second radio received signal by the separate signal processors and the processing of the first radio received signal and the second radio received signal by the separate intermediate-frequency signal processors is in sync.

14. The radio receiver as claimed in claim 1, wherein the signal processing apparatus is designed to measure the signal strength of the first radio received signal and of the second radio received signal.

15. The radio receiver as claimed in claim 1, wherein the antenna arrangement has a multi-feed antenna designed to receive a plurality of radio signals having different polarizations and to provide the signal processing apparatus with a plurality of radio received signals.

16. The radio receiver as claimed in claim 12, wherein the first radio received signal and the second radio received signal each have a separate signal processor and a separate intermediate-frequency signal processor provided for them, wherein the processing of the first radio received signal and the second radio received signal by the separate signal processors and the processing of the first radio received signal and the second radio received signal by the separate intermediate-frequency signal processors is in sync.
